(19) United States
(12) Patent Application Publication
(10) Pub. No.: US 2024/0267165 A1
(43) Pub. Date: Aug. 8, 2024

(54) ASSOCIATING A TRS WITH A SRS FOR DOPPLER SHIFT REPORTING

(71) Applicant: LENOVO (BEIJING) LIMITED, Beijing (CN)

(72) Inventors: Bingchao LIU, Beijing (CN); Chenxi ZHU, Fairfax, VA (US)

(21) Appl. No.: 18/249,470

(22) PCT Filed: Oct. 20, 2020
(86) PCT No.: PCT/CN2020/122043

§ 371 Date: Apr. 18, 2023

(51) Int. Cl. H04L 5/00; H04W 72/0446

(52) U.S. Cl. CPC H04L 5/0005; H04L 5/0051; H04W 72/0446

(57) ABSTRACT

Methods and apparatuses for implicitly reporting Doppler shift are disclosed. A method comprises receiving a configuration that indicates a TRS resource associated with a SRS resource for Doppler shift reporting; and transmitting the SRS resource, with a transmit frequency that is the same as a receive frequency of the TRS resource.

### FIELD

The subject matter disclosed herein generally relates to wireless communications, and more particularly relates to methods and apparatuses for implicitly reporting Doppler shift.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal) (UE), High Speed Train (HST), Single Frequency Network (SFN), Transmission and Reception Point (TRP), base station (BS), Frequency Range 1 (FR1), Frequency Range 2 (FR2), Quasi Colocation (QCL), Medium Access Control (MAC), control element (CE), Sounding Reference Signal (SRS), Aperiodic SRS (AP-SRS), Synchronization Signal Block (SSB), Tracking Reference Signal (TRS), Aperiodic TRS (AP-TRS), Physical Downlink Control Channel (PDCCH), Physical Downlink Shared Channel (PDSCH), Demodulation Reference Signal (DM-RS), Channel State Information (CSI), CSI Reference Signal (CSI-RS), Rank Indicator (RI), Precoding Matrix Indicator (PMI), Channel Quality Indicator (CQI), Bandwidth part (BWP), Non-Zero Power (NZP), Downlink control information (DCI).

For NR high speed train (HST), HST-SFN (single frequency network) deployment is the most important scenario, where all TRPs in the same cell transmit the same signals with the same time and frequency resources. The challenge in HST-SFN deployment scenario most comes from high Doppler shift caused by high speed (e.g., 500 km/hour), higher frequency (e.g., 2.6 GHz or 3.5 GHZ) and the characteristics of SFN deployment. For example, the Doppler shift can reach up to about 1.2 kHz for 2.6 GHz and about 1.6 kHz for 3.5 GHz. When the train is located in the middle of two TRPs, the UEs in the train may simultaneously experience +1.6 kHz and −1.6 kHz Doppler shifts from TRPs from different directions. The significant difference of the Doppler shifts experienced simultaneously by the UE will cause great performance degradation. One important enhancement method is to enable Doppler shift pre-compensation at TRP side (i.e. at gNB side) for SFN-based DL transmission so that UE will not experience significant different Doppler shifts from different TRPs.

The aim of the present invention is to provide a solution of implicitly reporting Doppler shift to support Doppler shift pre-compensation at BS side.

### BRIEF SUMMARY

Methods and apparatuses for implicitly reporting Doppler shift are disclosed.

In one embodiment, a method comprises receiving a configuration that indicates a TRS resource associated with a SRS resource for Doppler shift reporting; and transmitting the SRS resource, with a transmit frequency that is the same as a receive frequency of the TRS resource.

In one embodiment, the TRS resource may be a periodic TRS resource that can be associated with aperiodic SRS, or semi-persistent SRS or periodic SRS resource. In this condition, the transmit frequency of the SRS resource is the receive frequency of the latest received periodic TRS resource associated with the SRS resource before the slot for SRS transmission.

In another embodiment, the TRS resource may alternatively be an aperiodic TRS resource that can be associated with aperiodic SRS resource. In this condition, the aperiodic SRS resource and the associated aperiodic TRS resource are concurrently triggered by a same DCI containing an SRS request field with a non-zero value. The triggered aperiodic TRS resource is received in a slot that is the same as the slot receiving the DCI. The triggered aperiodic SRS resource is transmitted later than the reception of the triggered aperiodic TRS resource. In particular, a gap from the last symbol of the reception of the aperiodic TRS resource and the first symbol of the aperiodic SRS transmission is no less than a threshold.

In some embodiment, the method may further comprise receiving a MAC CE that updates the TRS resource associated with the SRS resource for Doppler shift reporting.

In another embodiment, a remote unit comprises a receiver that receives a configuration that indicates a TRS resource associated with a SRS resource for Doppler shift reporting; and a transmitter that transmits the SRS resource, with a transmit frequency that is the same as a receive frequency of the TRS resource.

In one embodiment, a method comprises transmitting a configuration that indicates a TRS resource associated with a SRS resource for Doppler shift reporting; and receiving the SRS resource, with a receive frequency.

In yet another embodiment, a base unit comprises a transmitter that transmits a configuration that indicates a TRS resource associated with a SRS resource for Doppler shift reporting; and a receiver that receives the SRS resource, with a receive frequency.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a Doppler shift pre-compensation procedure for FR1 scenario according to a first embodiment;

FIG. 2 illustrates a Doppler shift pre-compensation procedure for FR2 scenario according to a second embodiment;

FIGS. 3(a) to 3(d) illustrate four MAC CE formats according to a third embodiment;

FIG. 4 illustrates an example of concurrent triggering of AP-TRS and AP-SRS for Doppler shift reporting;

FIG. 5 is a schematic flow chart diagram illustrating an embodiment of a method;

FIG. 6 is a schematic flow chart diagram illustrating a further embodiment of a method; and

FIG. 7 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

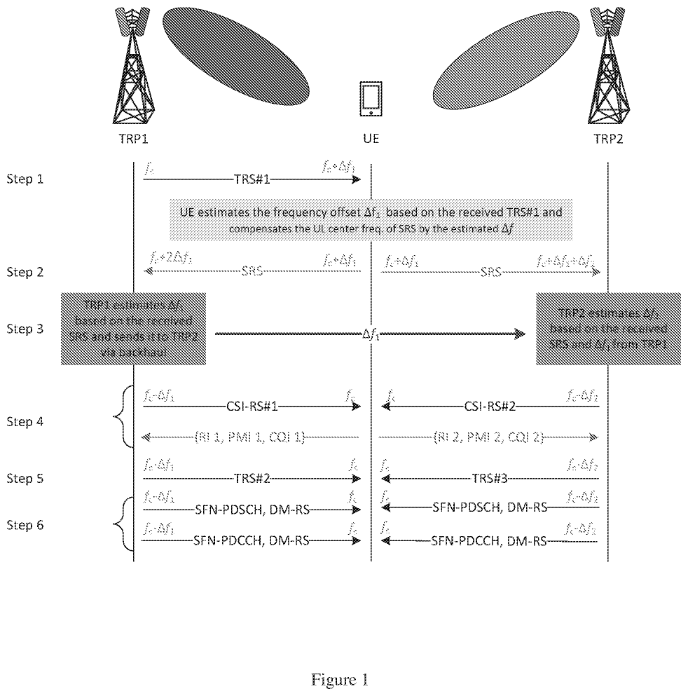

FIG. 1 illustrates a Doppler shift pre-compensation procedure for FR1 scenario according to a first embodiment. FR1 indicates a frequency band from 410 MHz to 7125 MHz. The directional lines represent the directions of the signals between TRP (TRP1 or TRP2) and UE, i.e. from TRP (TRP1 or TRP2) to UE or from UE to TRP (TRP1 or TRP2). The transmit frequencies of different signals are provided at the beginning side of each line and the receive frequencies of different signals are provided at the end side of each line.

It is assumed that a common local carrier frequency f_{c} is known by TRP1, TRP2 and UE. TRP1 and TRP2 are located at different locations. For example, in scenario of high speed train (HST), TRP1 and TRP2 are located near the train rail, along which UE moves, at different locations.

Step 1: TRP1 transmits TRS #1 by center frequency f_{c (}which is the local carrier frequency). TRS #1 is QCLed with an SSB resource by QCL-TypeC, i.e., {Doppler shift, average delay}. It means that the UE can obtain the Doppler shift and average delay of the wireless channel between TRP1 and the UE for the reception of TRS #1 from the estimation of SSB resource QCLed with TRS #1. Due to Doppler effect, a frequency offset Δf₁ (i.e. Doppler shift between TRP1 and UE) is experienced at the UE side. So, the receive frequency of TRS #1 becomes f_{c}+Δf₁ at the UE side.

Step 2: When UE transmits a SRS resource, it transmits the SRS resource with a frequency that is the same as the frequency (i.e. f_{c}+Δf₁) with which the UE receives TRS #1.

In FR1, the SRS resource is transmitted using an omnidirectional antenna, so that both TRP1 and TRP2 can receive the SRS resource. TRP1 receives the SRS resource with frequency f_{c}+Δf₁+Δf₁, where Δf₁ is the Doppler shift between TRP1 and UE. TRP2 receives the SRS resource with frequency f_{c}+Δf₁+Δf₂, where Δf₂ is the Doppler shift between TRP2 and UE.

In order to have a common understanding of the transmit frequency of the SRS resource between the UE and the BS (TRP1 or TRP2), it is necessary to establish an association between SRS resource used in step 2 and TRS resource used in step 1. For example, the SRS transmitted by the UE in step 2 can be associated with TRS #1 received in step 1. The detail of the association will be discussed later in the third embodiment.

As the transmission of the SRS resource can implicitly notify TRP of the Doppler shift (i.e. notify TRP1 of Δf₁ and notify TRP2 of Δf₂) of the DL channel, the association between SRS resource and TRS resource is used for implicitly reporting Doppler shift to TRP.

In step 3, based on the receive frequency f_{c}+Δf₁+Δf₁ and local carrier frequency f_{c}, the TRP1 can obtain Δf₁. On the other hand, TRP2 receives the SRS resource with frequency f_{c}+Δf₁+Af₂. In order to obtain Δf₂, TRP2 needs to know Δf₁. As an near-ideal backhaul is present between TRP1 and TRP2 in HST-SFN (high speed train, single frequency network) deployment, TRP1 can send Δf₁ to TRP2 via the near-ideal backhaul between TRP1 and TRP2. TRP2 can obtain Δf₂ according to the receive frequency of the SRS resource by TRP2, i.e. f_{c}+Δf₁+Δf₂, local carrier frequency f_{c}, and Δf₁ received from TRP1.

With Δf₁, TRP 1 can pre-compensate the Doppler shift for any of PDCCH, PDSCH, and corresponding DM-RS transmissions transmitted by TRP1. With Δf₂, TRP2 can pre-compensate the Doppler shift for any of PDCCH, PDSCH, and corresponding DM-RS transmissions transmitted by TRP2.

Because the TRPs will pre-compensate the Doppler shift for any of PDCCH, PDSCH, and DM-RS transmissions, it is preferable for the UE to perform CSI measurement based on a set of CSI-RS resources also transmitted with a frequency that has been pre-compensated with Doppler shift, i.e., the same frequency for SFN-PDSCH transmission, for appropriate PDSCH scheduling.

In step 4, TRP1 and TRP2 transmit two sets of CSI-RS resources, e.g. CSI-RS #1 and CSI-RS #2, respectively, with a frequency that has been pre-compensated with Doppler shift to the UE for CSI measurement. In particular, TRP1 transmits a set of CSI-RS resources, e.g. CSI-RS #1, with frequency f_{c}-Δf₁ to the UE. That is, the transmit frequency f_{c}-Δf₁ of CSI-RS #1 has been pre-compensated with Doppler shift Δf₁ between TRP1 and UE so that the UE will receive CSI-RS #1 with frequency f_{c}. The UE receives CSI-RS #1 with frequency f_{c}, computes CSI parameter set 1, e.g. {RI 1, PMI 1, CQI 1}, and reports the computed CSI parameter set 1 to TRP1 according to NR Release 15 CSI framework. Similarly, TRP2 transmits a set of CSI-RS resources, e.g. CSI-RS #2, with frequency f_{c}-Δf₂ to the UE. That is, the transmit frequency f_{c}-Δf₂ of CSI-RS #2 has been pre-compensated with Doppler shift Δf₂ between TRP2 and UE so that the UE will receive CSI-RS #2 with frequency f_{c}. The UE receives CSI-RS #2 with frequency f_{c}, and computes CSI parameter set 2, e.g. {RI 2, PMI 2, CQI 2}, and reports the computed CSI parameter set 2 to TRP2 according to NR Release 15 CSI framework. Different from CSI-RS without Doppler shift pre-compensation, each of the CSI-RS resources transmitted with a frequency that has been pre-compensated with Doppler shift can be QCLed with a SSB resource by average delay and if applicable, by QCL-TypeD, i.e., {spatial RX filter}. When two resources are QCLed by QCL-TypeD, they are transmitted using the same spatial TX filter and can be received by using the same spatial RX filter. So, if applicable, each of the CSI-RS resources can be transmitted with same spatial TX filter as that for transmitting the SSB resource by the UE and can be received by using the same spatial RX filter as that for receiving the SSB resource.

In Step 5, TRP1 and TRP2 transmit two TRS resources, respectively, with a frequency that has been pre-compensated with Doppler shift, i.e., with center frequency f_{c}-Δf₁ and f_{c}-Δf₂, to the UE for the frequency and timing tracking for PDCCH or PDSCH reception with Doppler shift pre-compensation. In particular, TRP1 transmits a TRS resource, e.g., TRS #2, with frequency f_{c}-Δf₁. The UE receives TRS #2 with frequency f_{c}. TRP2 transmits a TRS resource, e.g., TRS #3, with frequency f_{c}-Δf₂. The UE receives TRS #3 with frequency f_{c}. Each of TRS #2 and TRS #3 with Doppler shift pre-compensation can be QCLed with a SSB resource by average delay and delay spread, and if applicable, by QCL-TypeD, i.e., {spatial RX filter}. So, if applicable, each of TRS #2 and TRS #3 can be transmitted with same spatial TX filter as that for transmitting the SSB resource and can be received by the same spatial RX filter as that for receiving the SSB resource.

In step 6, TRP1 transmits SFN-PDCCH, SFN-PDSCH and corresponding DM-RS by the compensated center frequency f_{c}-Δf₁. In addition, TRP2 transmits SFN-PDCCH, SFN-PDSCH and corresponding DM-RS by the compensated center frequency f_{c}-Δf₂.

If DM-RS is transmitted by SFN manner, i.e., the same DM-RS port(s) are transmitted by two TRPs (TRP1 and TRP2), two TCI states are indicated to the DM-RS port of SFN-PDCCH or the DM-RS port(s) assigned for SFN-PDSCH. The first TCI state contains TRS #2 with QCL-TypeA, i.e., {Doppler shift, Doppler spread, average delay, delay spread}. It means that the UE will apply the Doppler shift, Doppler spread, average delay and delay spread obtained from the reception of TRS #2 to the reception of DM-RS from TRP1. The second TCI state contains TRS #3 with QCL-TypeA, i.e., {Doppler shift, Doppler spread, average delay, delay spread} to indicate the QCL assumption for DM-RS ports transmitted by TRP2. It means that the UE will apply the Doppler shift, Doppler spread, average delay and delay spread obtained from the reception of TRS #3 to the reception of DM-RS from TRP2.

If DM-RS is transmitted by non-SFN manner, i.e., two different DM-RS port sets are transmitted by two TRPs (TRP1 and TRP2), respectively. The first DM-RS port set is transmitted from TRP1 and QCLed with TRS #2 by QCL-TypeA, i.e., {Doppler shift, Doppler spread, average delay, delay spread}. The second DM-RS port set is transmitted from TRP2 and QCLed with TRS #3 by QCL-TypeA, i.e., {Doppler shift, Doppler spread, average delay, delay spread}.

It can be seen that steps 4-6 in FIG. 1 are optional for Doppler shift pre-compensation procedure. In steps 2 and 3, the Doppler shift Δf₁ is known by TRP1 and the Doppler shift Δf₂ is known by TRP2.

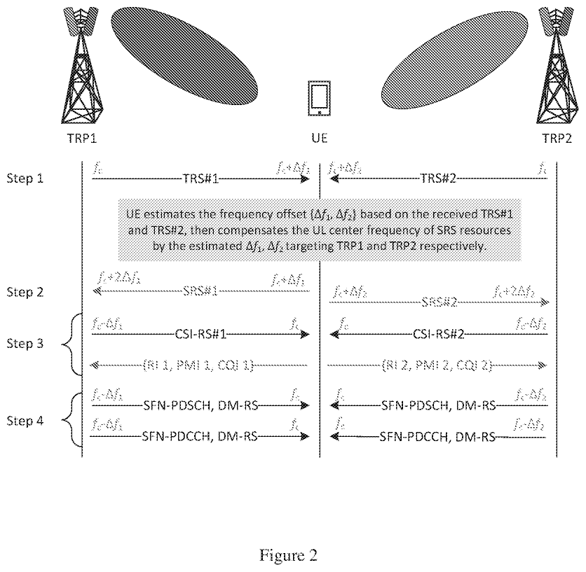

FIG. 2 illustrates a Doppler shift pre-compensation procedure for FR2 scenario according to the second embodiment. FR2 indicates a frequency band from 24.25 GHz to 52.6 GHz. The main difference of the second embodiment from the first embodiment is that the UE transmits different SRS resources using directional antennas targeting different TRPs, and the UE does not have the capability of simultaneously transmitting two SRS resources targeting two TRPs using different beams.

Similar to the first embodiment, it is also assumed that a common local carrier frequency f_{c} is known by TRP1, TRP2 and UE according to the second embodiment. TRP1 and TRP2 are located at different locations. For example, in scenario of high speed train (HST), TRP1 and TRP2 are located near the train rail, along which UE moves, at different locations.

Step 1: TRP1 and TRP2 transmit TRS #1 and TRS #2, respectively, with center frequency f_{c}. TRS #1 and TRS #2 are QCLed with two different SSB resources by QCL-TypeC, i.e., {Doppler shift, average delay}. It means that the UE can obtain the Doppler shift and average delay of the wireless channel between TRP1 and the UE for the reception of TRS #1 from the reception of a SSB resource QCLed with TRS #1, and obtain the Doppler shift and average delay of the wireless channel between TRP #2 and the UE for the reception of TRS #2 from the reception of another SSB resource QCLed with TRS #2. Due to Doppler effect, the receive frequency of TRS #1 becomes f_{c}+Δf₁ at the UE side; and the receive frequency of TRS #2 becomes f_{c}+Δf₂ at the UE side.

Step 2: When UE transmits a SRS resource, e.g. SRS #1, to TRP1, it transmits SRS #1 with a frequency that is the same as the frequency (i.e. f_{c}+Δf₁) with which the UE receives TRS #1, using the same spatial relation for receiving TRS #1. When UE transmits another SRS resource, e.g. SRS #2, to TRP2, it transmits SRS #2 with a frequency that is the same as the frequency (i.e. f_{c}+Af₂) with which the UE receives TRS #2, using the same spatial relation for receiving TRS #2.

In FR2, the SRS resource is transmitted using directional antennas. When the UE does not have the capability of simultaneously transmitting two SRS resources targeting two TRPs using different beams, the UE transmits SRS #1 and SRS #2, separately, using different beams respectively that are used for receiving TRS #1 and TRS #2.

TRP1 receives SRS #1 with frequency f_{c}+Δf₁+Δf₁=f_{c}+2Δf₁, where Δf₁ is the Doppler shift between TRP1 and UE. Accordingly, TRP #1 can obtain Δf₁ based on the receive frequency f_{c}+2Δf₁ and local carrier frequency f_{c}. TRP2 receives SRS #2 with frequency f_{c}+Δf₂+Δf₂=f_{c}+2Δf₂, where Δf₂ is the Doppler shift between TRP2 and UE. Accordingly, TRP #2 can obtain Δf₂ based on the receive frequency f_{c}+2Δf₂ and local carrier frequency f_{c}.

In order to have a common understanding of the transmit frequencies of the SRS resources, it is necessary to establish an association between each SRS resource used in step 2 and each TRS resource used in step 1. For example, SRS #1 transmitted by the UE in step 2 can be associated with TRS #1 received in step 1, and SRS #2 transmitted by the UE in step 2 can be associated with TRS #2 received in step 1. The detail of the association will be discussed later in the third embodiment.

As the transmission of the SRS resource (SRS #1 and SRS #2) can implicitly notify TRP of the Doppler shift (i.e. notify TRP1 of Δf₁ and notify TRP2 of Δf₂), the association between each SRS resource and each TRS resource is used for implicitly reporting Doppler shift to TRP.

Because the TRPs will pre-compensate the Doppler shift for any of PDCCH, PDSCH, and corresponding DM-RS transmissions, it is preferable for the UE to perform CSI measurement based on a set of CSI-RS resources transmitted also with a frequency that has been pre-compensated with Doppler shift.

Step 3 of the second embodiment is the same as Step 4 of the first embodiment. In particular, in step 3 of FIG. 2, TRP1 and TRP2 transmit two sets of CSI-RS resources, e.g. CSI-RS #1 and CSI-RS #2, respectively, with a frequency that has been pre-compensated with Doppler shift to the UE for CSI measurement. In particular, TRP1 transmits a set of CSI-RS resources, e.g. CSI-RS #1, with frequency f_{c}-Δf₁ to the UE. That is, the transmit frequency f_{c}-Δf₁ of CSI-RS #1 has been pre-compensated with Doppler shift Δf₁ between TRP1 and UE so that the UE will receive CSI-RS #1 with frequency f_{c}. The UE receives CSI-RS #1 with frequency f_{c}, computes CSI parameter set 1, e.g. {RI 1, PMI 1, CQI 1}, and reports the computed CSI parameter set 1 to TRP1 according to NR Release 15 CSI framework. Similarly, TRP2 transmits a set of CSI-RS resources, e.g. CSI-RS #2, with frequency f_{c}-Δf₂ to the UE. That is, the transmit frequency f_{c}-Δf₂ of CSI-RS #2 has been pre-compensated with Doppler shift Δf₂ between TRP2 and UE so that the UE will receive CSI-RS #2 with frequency f_{c}. The UE receives CSI-RS #2 with frequency f_{c}, and computes CSI parameter set 2, e.g. {RI 2, PMI 2, CQI 2}, and reports the computed CSI parameter set 2 to TRP2 according to NR Release 15 CSI framework.

In step 4, TRP1 transmits SFN-PDCCH, SFN-PDSCH and corresponding DM-RS by the compensated center frequency f_{c}-Δf₁. In addition, TRP2 transmits SFN-PDCCH, SFN-PDSCH and corresponding DM-RS by the compensated center frequency f_{c}-Δf₂.

DM-RS port(s) from TRP1 are QCLed with TRS #1 by average delay and delay spread, and if applicable by QCL-TypeD, i.e., {spatial Rx parameter}. DM-RS ports from TRP2 are QCLed with TRS #2 with average delay and delay spread, and if applicable by QCL-TypeD i.e., {spatial Rx parameter}.

As indicated in steps 1 and 2 of both the first embodiment and the second embodiment, a TRS resource received in step 1 should be associated with each SRS resource transmitted in step 2 for the UE and gNB to have a common understanding on the receive frequency (from TRP's point of view) (or transmit frequency from UE's point of view) of the transmitted SRS resource (e.g. SRS in FIG. 1, and SRS #1 and SRS #2 in FIG. 2), where the center frequency (transmit frequency from UE's point of view) of the SRS resource is determined by the receive frequency of the TRS resource associated with the SRS resource. In the first embodiment, the center frequency (transmit frequency) of the SRS resource is determined according to the receive frequency of TRS #1 associated with the SRS resource. In the second embodiment, TRS #1 is associated with SRS #1 and the transmit frequency of SRS #1 is determined according to the receive frequency of TRS #1, while TRS #2 is associated with SRS #2 and the transmit frequency of SRS #2 is determined according to the receive frequency of TRS #2.

The third embodiment describes the association between SRS resource and TRS resource.

An SRS resource set containing up to 2 SRS resources can be configured for estimation of frequency offset, i.e., Doppler shift, as the example provided in Table 1. Each SRS resource contained in the SRS resource set is configured with an associated TRS resource by the higher layer parameter associated CSI-RS.

TABLE 1

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) OF |
| SRS-ResourceId | |
| resourceType | CHOICE { |
| aperiodic | SEQUENCE { |

aperiodicSRS-ResourceTrigger INTEGER (1..maxNrofSRS-TriggerStates-1);

| | |
|---|---|
| associatedCSI-RS | NZP-CSI-RS-ResourceId: |
| slotOffset | INTEGER (1..32) |
| }, | |
| semi-persistent | SEQUENCE { |
| associatedCSI-RS | NZP-CSI-RS-ResourceId |
| }, | |
| periodic | SEQUENCE { |
| associatedCSI-RS | NZP-CSI-RS-ResourceId |
| } | |
| }, | |
| usage | ENUMERATED {beamManagement, codebook, nonCodebook, |
| antennaSwitching, DopplerShift }, | |
| alpha | Alpha |
| p0 | INTEGER (−202..24) |
| pathlossReferenceRS | PathlossReferenceRS-Config |
| srs-PowerControlAdjustmentStates | ENUMERATED {sameAsFci2, separateclosedLoop} |
| } | |

The associated CSI-RS is an NZP CSI-RS configured with higher layer parameter trs-info for identifying a TRS resource, and it is only configured when the usage is set to DopplerShift, which is used for identifying a SRS resource set for Doppler shift reporting. Accordingly, the association of each of the SRS resource(s) contained in the SRS resource set with a TRS resource can be configured by RRC signaling illustrated in Table 1. The configuration signaling for the association can be transmitted by any of TRP1 or TRP2.

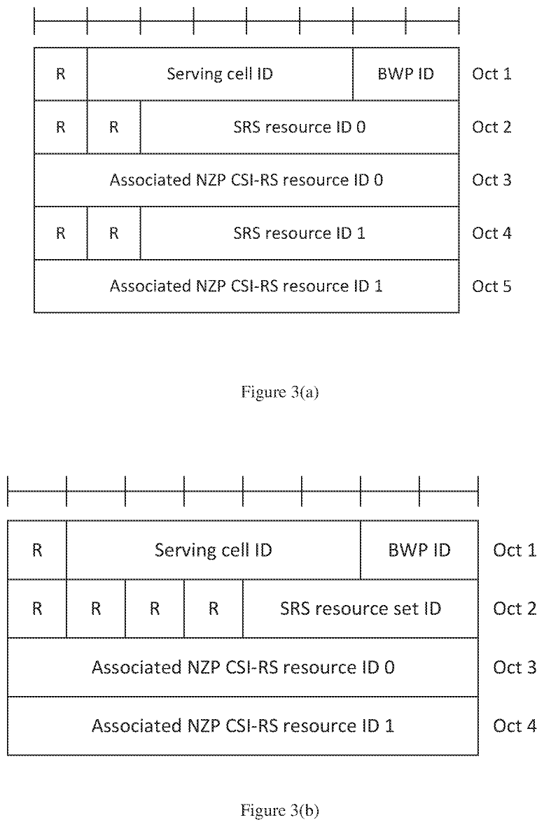

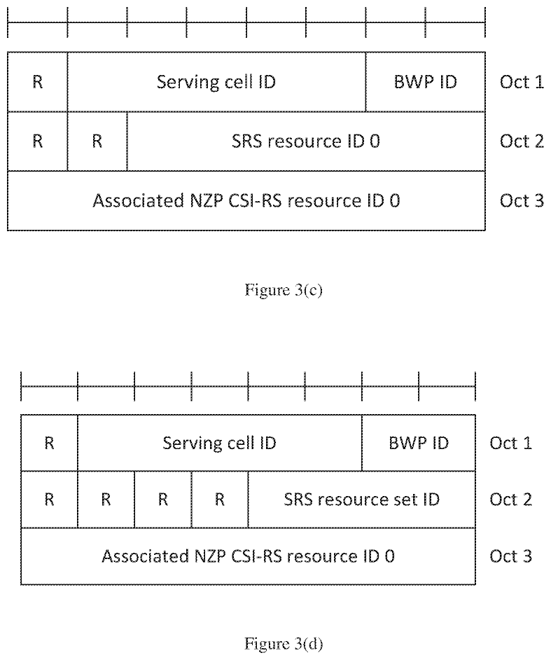

The associated TRS resource for SRS resource can be further updated by MAC CE with format illustrated in FIG. 3(a) or FIG. 3(b). The following fields are contained.

Serving cell ID (with 5 bits): This field indicates the identity of the serving cell for which the MAC CE applies. Up to 32 serving cells can be configured to a UE.

BWP ID (with 2 bits): This field indicates the identity of the BWP for which the MAC CE applies. Up to 4 BWPs can be configured in a cell.

SRS resource ID: The SRS resource ID 0 and SRS resource ID 1 in FIG. 3(a) identify the SRS resources for Doppler shift reporting. Up to 64 SRS resources can be configured in a BWP. So, the length of each SRS resource ID field is 6.

SRS resource set ID: The SRS resource set ID in FIG. 3(b) identifies SRS resource set with the usage set as ‘DopplerShift’. Up to 16 SRS resource sets can be configured in a BWP. So, the length of SRS resource set ID field is 4.

Associated NZP CSI-RS resource ID: The associated NZP CSI-RS resource ID 0 and associated NZP CSI-RS resource ID 1 in FIG. 3(a) and FIG. 3(b) identify NZP CSI-RS resources with higher layer parameter trs-info associated with the SRS resources for Doppler shift reporting. The NZP CSI-RS resource identified by associated NZP CSI-RS resource ID 0 is associated with the SRS resource identified by SRS resource ID 0; and NZP CSI-RS resource identified by associated NZP CSI-RS resource ID 1 is associated with the SRS resource identified by SRS resource ID 1. In FIG. 3(b), it is assumed that the SRS resource set identified by SRS resource set ID contains SRS resource 0 to be associated with the NZP CSI-RS resource identified by associated NZP CSI-RS resource ID 0 and SRS resource 1 to be associated with the NZP CSI-RS resource identified by associated NZP CSI-RS resource ID 1. Up to 192 NZP CSI-RS resources can be configured in a BWP. So, the length of each associated NZP CSI-RS resource ID field is 8.

FIGS. 3(a) and 3(b) illustrate the formats of MAC CE for updating associated TRS resource (NZP CSI-RS resource configured as TRS resource) of each of two SRS resources contained in a SRS resource set for frequency offset estimation. If the SRS resource set for frequency offset estimation contains only one SRS resource, the MAC CE format shown in FIG. 3(a) can be changed to a MAC CE format shown in FIG. 3(c). In particular, the MAC CE format shown in FIG. 3(c) is obtained by removing the octets 4 and 5 of the MAC CE format shown in FIG. 3(a). Similarly, the MAC CE format shown in FIG. 3(b) can be changed to a MAC CE format shown in FIG. 3(d). In particular, the MAC CE format shown in FIG. 3(d) is obtained by removing the octet 4 of the MAC CE format shown in FIG. 3(b).

New SRS resource set can be configured for the purpose of Doppler shift reporting, e.g. with the usage of DopplerShift. Up to two SRS resources are configured in the SRS resource set for the purpose of Doppler shift reporting. For example, for the first embodiment, one SRS resource can be configured in the SRS resource set for the purpose of Doppler shift reporting; and for the second embodiment, two SRS resources can be configured in the SRS resource set for the purpose of Doppler shift reporting.

Alternatively, a Release 16 SRS resource set, e.g. the SRS resource set for codebook based UL transmission, can be reused (configured to be used) as the SRS resource set for the purpose of Doppler shift reporting.

As a whole, the associated TRS resource for each SRS resource is configured by RRC signaling. In addition, the associated TRS resource for each SRS resource can be updated by MAC CE shown in any of FIGS. 3(a) to 3(d).

For the SRS resource associated with TRS resource in FR2 according to the second embodiment, the UE shall transmit the SRS resource using the spatial relation determined by the spatial RX filter of the associated TRS resource. That is, with reference to FIG. 2, the UE shall transmit SRS #1 with the same spatial domain transmission filter used for the reception of TRS #1 associated with SRS #1; and transmit SRS #2 with the same spatial domain transmission filter used for the reception of TRS #2 associated with SRS #2. The UE does not expect to be configured with both spatialRelationInfo for SRS resource and associated CSI-RS. That is, if a SRS resource for Doppler shift reporting is configured with an associated TRS resource (i.e. an associated CSI-RS resource configured with higher layer parameter trs-info to be identified as an associated TRS resource), it does not expect to be configured with a spatialRelationInfo.

TRS resource can be periodic or aperiodic. SRS resource can be aperiodic, periodic or semi-persistent.

Periodic TRS resource can be associated with an aperiodic, periodic or semi-persistent SRS resource. In particular, the latest received periodic TRS resource before the slot for SRS transmission is the TRS resource to determine the transmit frequency of the SRS resource associated with the periodic TRS resource. That is, the receive frequency of the latest received periodic TRS resource before the slot for SRS transmission is used as the transmit frequency of SRS resource associated with the periodic TRS resource.

Aperiodic TRS resource can be associated only with aperiodic SRS resource. The aperiodic TRS resource and aperiodic SRS resource are concurrently triggered by one DCI with non-zero SRS request field. The “DCI with non-zero SRS request field” means that the SRS request field of the DCI has a non-zero request field value (non-zero value), which is referred to as an aperiodic SRS triggering state. Because the aperiodic SRS resource triggered by a DCI is associated with an aperiodic TRS resource, the DCI triggering the aperiodic SRS resource also triggers the aperiodic TRS resource associated with the triggered aperiodic SRS resource. The triggered aperiodic TRS resource is received within a slot that is the same as the slot receiving the DCI containing SRS request field with a non-zero value. The triggered SRS resource is transmitted after the reception of the triggered associated TRS resource. The gap between the last symbol of received associated TRS resource and the first symbol for SRS transmission should no less than a threshold for Doppler shift computation and transmission frequency preparation. The threshold can be expressed as several number of OFDM symbols dependent on UE capability reporting. Alternatively, the threshold may be a fixed value, e.g., 42 OFDM symbols.

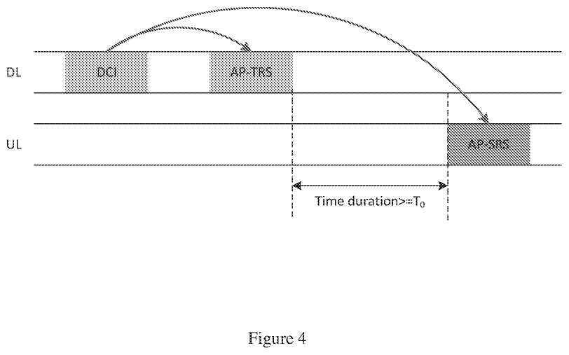

An example of concurrent triggering of aperiodic TRS resource (AP-TRS) and aperiodic SRS resource (AP-SRS) for Doppler shift reporting is shown in FIG. 4.

An aperiodic SRS resource set containing one or two SRS resources is configured with the usage of DopplerShift. Each SRS resource (AP-SRS) is associated with an aperiodic TRS resource (AP-TRS).

The presence of the associated TRS is indicated by the SRS request field with non-zero value. The AP-TRS is transmitted in a slot that is the same as the slot (slot n) receiving the DCI containing the SRS request field. The triggered SRS resource is transmitted in slot n+k to ensure that a time duration from the last symbol of the reception of the aperiodic TRS resource and the first symbol of the aperiodic SRS transmission should be no less than a threshold T₀ (e.g., 42 OFDM symbols). The time duration (>=T₀) guarantees that the UE has enough time to estimate Doppler shift and adjust the center frequency of the SRS transmission.

From the point of view of the transmission of SRS resource, the SRS resource transmitted in step 2 of both the first and the second embodiments can be aperiodic, periodic or semi-persistent SRS resource.

When the SRS resource is aperiodic SRS resource, it can be associated with an aperiodic TRS resource or a periodic TRS resource. When the aperiodic SRS resource is associated with the aperiodic TRS resource, the aperiodic SRS resource and the aperiodic TRS resource are concurrently triggered by a same DCI, as described with reference to FIG. 4. The triggered aperiodic SRS resource is transmitted with a transmit frequency that is the same as a receive frequency for receiving the triggered aperiodic TRS resource. When the aperiodic SRS resource is associated with the periodic TRS resource, the aperiodic SRS resource triggered by a DCI is transmitted with a transmit frequency that is the same as a receive frequency for receiving the latest periodic TRS resource (that is associated with the aperiodic SRS resource) before the slot for transmission of the triggered aperiodic SRS resource.

When the SRS resource is periodic or semi-persistent SRS resource, it can be associated with a periodic TRS resource. When periodic or semi-persistent SRS resource is configured or activated, the configured periodic or activated semi-persistent SRS resource is transmitted with a transmit frequency that is the same as a receive frequency for receiving the latest periodic TRS resource (that is associated with the periodic or semi-persistent SRS resource) before the slot for transmission of the configured periodic or activated semi-persistent SRS resource.

In scenario of high speed train (HST), the UE is moving at a high speed along the train rail. So, the Doppler shift between UE and TRP (e.g. TRP1 and TRP2) is always changing. Therefore, the Doppler shift pre-compensation procedure will be performed before each PDSCH/PDCCH transmission, and the Doppler shift implicitly reported by transmitting SRS resource can be performed periodically. The periodical performance of the Doppler shift reporting procedure depends on periodical transmission of the SRS resource in step 2 of FIGS. 1 and 2. When the SRS resource transmitted in step 2 of FIGS. 1 and 2 is a periodic SRS resource, it is obviously transmitted periodically. When the SRS resource transmitted in step 2 of FIGS. 1 and 2 is a semi-persistent SRS resource, it can be activated periodically by a corresponding MAC CE.

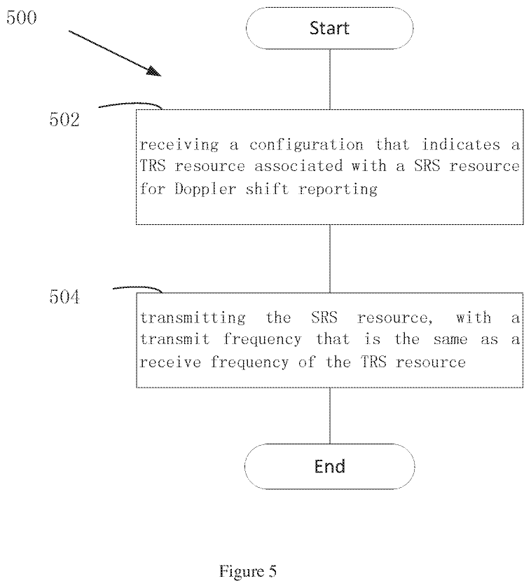

FIG. 5 is a schematic flow chart diagram illustrating an embodiment of a method 500 according to the present application. In some embodiments, the method 500 is performed by an apparatus, such as a remote unit. In certain embodiments, the method 500 may be performed by a processor executing program code, for example, a microcontroller, a microprocessor, a CPU, a GPU, an auxiliary processing unit, a FPGA, or the like.

The method 500 may include 502 receiving a configuration that indicates a TRS resource associated with a SRS resource for Doppler shift reporting; and 504 transmitting the SRS resource, with a transmit frequency that is the same as a receive frequency of the TRS resource.

The configuration may be a RRC signaling indicating one or two TRS resources each of which is associated with each of one or two SRS resources in a SRS resource set.

The SRS resource set with one SRS resource is configured for Doppler shift reporting in FR1. The one SRS resource is associated with a TRS resource while the receive frequency of the associated TRS resource determines the transmit frequency of the one SRS resource.

The SRS resource set with two SRS resources is configured for Doppler shift reporting in FR2. Each of the two SRS resources is associated with a separate TRS resource, and transmitted with a frequency determined by the receive frequency of the separate TRS resource.

In the method 500, the TRS resource may be a periodic TRS resource that can be associated with aperiodic SRS, or semi-persistent SRS or periodic SRS resource. In this condition, the transmit frequency of the SRS resource is the receive frequency of the latest received periodic TRS resource associated with the SRS resource before the slot for SRS transmission.

In the method 500, the TRS resource may alternatively be an aperiodic TRS resource that can be associated with aperiodic SRS resource. In this condition, the aperiodic SRS resource and the associated aperiodic TRS resource are concurrently triggered by a same DCI containing an SRS request field with a non-zero value. The triggered aperiodic TRS resource is received in a slot that is the same as the slot receiving the DCI. The triggered aperiodic SRS resource is transmitted later than the reception of the triggered aperiodic TRS resource. In particular, a gap from the last symbol of the reception of the aperiodic TRS resource and the first symbol of the aperiodic SRS transmission is no less than a threshold.

The method 500 may further comprise receiving a MAC CE that updates the TRS resource associated with the SRS resource for Doppler shift reporting.

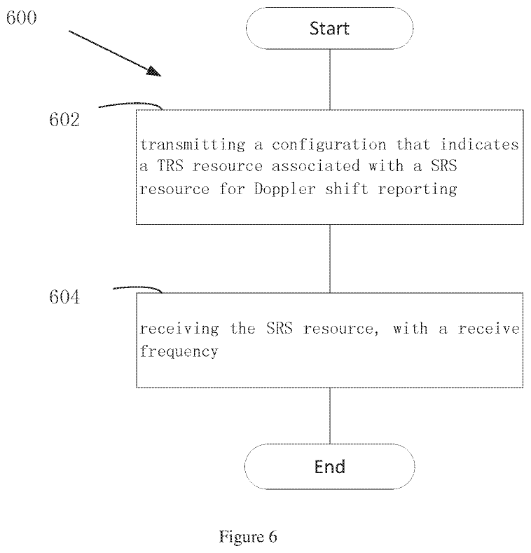

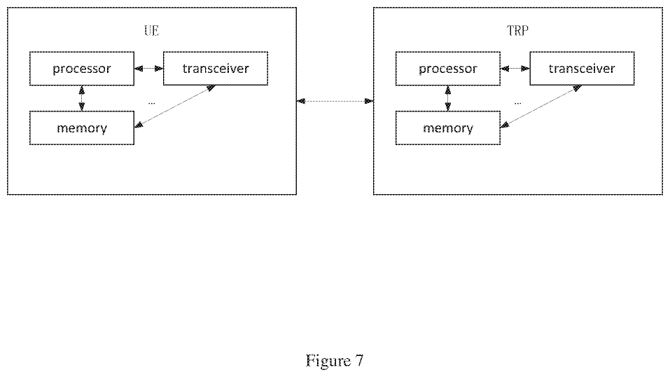

FIG. 6 is a schematic flow chart diagram illustrating an embodiment of a method 600 according to the present application. In some embodiments, the method 600 is performed by an apparatus, such as a TRP. In certain embodiments, the method 600 may be performed by a processor executing program code, for example, a microcontroller, a microprocessor, a CPU, a GPU, an auxiliary processing unit, a FPGA, or the like.

The method 600 may include 602 transmitting a configuration that indicates a TRS resource associated with a SRS resource for Doppler shift reporting; and 604 receiving the SRS resource, with a receive frequency.

The method 600 may further comprises: transmitting a MAC CE that updates the TRS resource associated with the SRS resource for Doppler shift reporting.

The method 600 may further comprises transmitting the TRS resource with a transmit frequency; and estimating a Doppler shift according to the transmit frequency of the TRS resource and the receive frequency of the SRS resource. Alternatively, the method 600 may further comprises estimating a Doppler shift according to a local center frequency, the receive frequency of the SRS resource, and an estimated Doppler shift of another TRP, wherein the estimated Doppler shift of another TRP is received from the other TRP. As shown in step 3 of FIG. 1, TRP1, that transmits associated TRS #1 in step 1, transmits its estimated Doppler shift to TRP2.

When the Doppler shift is estimated, the method 600 may further comprise transmitting PDSCH, PDCCH and corresponding DM-RSs with a frequency compensated by the estimated Doppler shift.

In the method 600, the TRS resource may be a periodic TRS resource that can be associated with aperiodic SRS, or semi-persistent SRS or periodic SRS resource. In this condition, the SRS resource will be transmitted by a UE with a transmit frequency that is the same as the frequency for the UE to receive the latest periodic TRS resource associated with the SRS resource before the slot for SRS transmission.

Alternatively, the TRS resource may be an aperiodic TRS resource that can be associated with aperiodic SRS resource. In this condition, the aperiodic SRS resource and the associated aperiodic TRS resource are concurrently triggered by a same DCI containing an SRS request field with a non-zero value. In this condition, the triggered aperiodic TRS resource is transmitted in a slot that is the same as the slot transmitting the DCI. The triggered aperiodic SRS resource will be received later than the transmission of the triggered aperiodic TRS resource. In particular, a gap from the last symbol of the transmission of the aperiodic TRS resource and the first symbol to receive the aperiodic SRS resource is no less than a threshold.

FIG. 7 is a schematic block diagram illustrating apparatuses according to one embodiment.

Referring to FIG. 7, the UE (i.e. the remote unit) includes a processor, a memory, and a transceiver. The processor implements a function, a process, and/or a method which are proposed in FIG. 5. In particular, the remote unit comprises a receiver that receives a configuration that indicates a TRS resource associated with a SRS resource for Doppler shift reporting; and a transmitter that transmits the SRS resource, with a transmit frequency that is the same as a receive frequency of the TRS resource.

The TRS resource may be a periodic TRS resource that can be associated with aperiodic SRS, or semi-persistent SRS or periodic SRS resource. In this condition, the transmit frequency of the SRS resource is the receive frequency of the latest received periodic TRS resource associated with the SRS resource before the slot for SRS transmission.

The TRS resource may alternatively be an aperiodic TRS resource that can be associated with aperiodic SRS resource. In this condition, the aperiodic SRS resource and the associated aperiodic TRS resource are concurrently triggered by a same DCI containing an SRS request field with a non-zero value. The triggered aperiodic TRS resource is received in a slot that is the same as the slot receiving the DCI. The triggered aperiodic SRS resource is transmitted later than the reception of the triggered aperiodic TRS resource. In particular, a gap from the last symbol of the reception of the aperiodic TRS resource and the first symbol of the aperiodic SRS transmission is no less than a threshold.

The receiver may further receive a MAC CE that updates the TRS resource associated with the SRS resource for Doppler shift reporting.

The TRP (i.e. base unit) includes a processor, a memory, and a transceiver. The processors implement a function, a process, and/or a method which are proposed in FIG. 6. In particular, the base unit comprises a transmitter that transmits a configuration that indicates a TRS resource associated with a SRS resource for Doppler shift reporting; and a receiver that receives the SRS resource, with a receive frequency.

The transmitter may further transmit a MAC CE that updates the TRS resource associated with the SRS resource for Doppler shift reporting.

The transmitter may further transmit the TRS resource with a transmit frequency, while the base unit further comprises a processor that estimates a Doppler shift according to the transmit frequency of the TRS resource and the receive frequency of the SRS resource. Alternatively, the base unit further comprises a processor that estimates a Doppler shift according to a local center frequency, the receive frequency of the SRS resource, and an estimated Doppler shift of another TRP, wherein the estimated Doppler shift of another TRP is received from the other TRP.

When the Doppler shift is estimated, the transmitter may further transmit PDSCH, PDCCH and corresponding DM-RSs with a frequency compensated by the estimated Doppler shift.

The TRS resource may be a periodic TRS resource that can be associated with aperiodic SRS, or semi-persistent SRS or periodic SRS resource. In this condition, the SRS resource will be transmitted by a UE with a transmit frequency that is the same as the frequency for the UE to receive the latest periodic TRS resource associated with the SRS resource before 25 the slot for SRS transmission.

Alternatively, the TRS resource may be an aperiodic TRS resource that can be associated with aperiodic SRS resource. In this condition, the aperiodic SRS resource and the associated aperiodic TRS resource are concurrently triggered by a same DCI containing an SRS request field with a non-zero value. In this condition, the transmitter transmits the triggered aperiodic TRS resource in a slot that is the same as the slot transmitting the DCI. The receiver will receive the triggered aperiodic SRS resource later than the transmission of the triggered aperiodic TRS resource. In particular, a gap from the last symbol of the transmission of the aperiodic TRS resource and the first symbol to receive the aperiodic SRS resource is no less than a threshold.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A remote unit, comprising:
a receiver that receives a configuration that indicates a tracking reference signal (TRS) resource associated with a sounding reference signal (SRS) resource for Doppler shift reporting; and
a transmitter that transmit the SRS resource with a transmit frequency that is the same as a receive frequency of the TRS resource.

2. The remote unit of claim 1, wherein the TRS resource is a periodic TRS resource that can be associated with aperiodic SRS, or semi-persistent SRS or periodic SRS resource.

3. The remote unit of claim 2, wherein, the transmit frequency of the SRS resource is the receive frequency of the latest received periodic TRS resource associated with the SRS resource before the slot for SRS transmission.

4. The remote unit of claim 1, wherein, the TRS resource is an aperiodic TRS resource that can be associated with aperiodic SRS resource.

5. The remote unit of claim 4, wherein, the aperiodic SRS resource and the associated aperiodic TRS resource are concurrently triggered by a same downlink control information (DCI) containing an SRS request field with a non-zero value.

6. The remote unit of claim 5, wherein the triggered aperiodic TRS resource is received in a slot that is the same as the slot receiving the DCI.

7. The remote unit of claim 5, wherein, a gap from the last symbol of the reception of the aperiodic TRS resource and the first symbol of the aperiodic SRS transmission is no less than a threshold.

8. The remote unit of claim 1, further comprising: receiving a medium access control (MAC) control element (CE) that updates the TRS resource associated with the SRS resource for Doppler shift reporting.

9. A transmission and reception point (TRP), comprising:
transmitting a configuration that indicates a tracking reference signal (TRS) resource associated with a sounding reference signal (SRS) resource for Doppler shift reporting; and
receiving the SRS resource with a receive frequency.

10. The TRP of claim 9, further comprising:
transmitting the TRS resource with a transmit frequency; and
estimating a Doppler shift according to the transmit frequency of the TRS resource and the receive frequency of the SRS resource.

11. The TRP of claim 9, further comprising: estimating a Doppler shift according to a local center frequency, the receive frequency of the SRS resource, and an estimated Doppler shift of another TRP, wherein the estimated Doppler shift of another TRP is received from the other TRP.

12. The TRP of claim 10, further comprising: transmitting physical downlink shared channel (PDSCH), physical downlink control channel (PDCCH) and corresponding demodulation reference signals (DM-RSs) with a frequency compensated by the estimated Doppler shift.

13. (canceled)

14. (canceled)

15. A method, comprising:
receiving a configuration that indicates a tracking reference signal (TRS) resource associated with a sounding reference signal (SRS) resource for Doppler shift reporting; and
transmitting the SRS resource with a transmit frequency that is the same as a receive frequency of the TRS resource.

16. The method of claim 15, wherein the TRS resource is a periodic TRS resource that can be associated with aperiodic SRS, or semi-persistent SRS or periodic SRS resource.

17. The method of claim 16, wherein, the transmit frequency of the SRS resource is the receive frequency of the latest received periodic TRS resource associated with the SRS resource before the slot for SRS transmission.

18. The method of claim 15, wherein, the TRS resource is an aperiodic TRS resource that can be associated with aperiodic SRS resource.

19. The method of claim 18, wherein, the aperiodic SRS resource and the associated aperiodic TRS resource are concurrently triggered by a same downlink control information (DCI) containing an SRS request field with a non-zero value.

20. The method of claim 19, wherein the triggered aperiodic TRS resource is received in a slot that is the same as the slot receiving the DCI.

21. The method of claim 19, wherein, a gap from the last symbol of the reception of the aperiodic TRS resource and the first symbol of the aperiodic SRS transmission is no less than a threshold.

22. The method of claim 15, further comprising: receiving a medium access control (MAC) control element (CE) that updates the TRS resource associated with the SRS resource for Doppler shift reporting.
